(19) United States
(12) Patent Application Publication
(10) Pub. No.: US 2024/0331009 A1
(43) Pub. Date: Oct. 3, 2024

(54) INFORMATION PROCESSING APPARATUS, INFORMATION PROCESSING METHOD, AND NON-TRANSITORY STORAGE MEDIUM

(71) Applicants: TOYOTA JIDOSHA KABUSHIKI KAISHA, Toyota-shi (JP); DENSO TEN Limited, Kobe (JP)

(72) Inventors: Ryogo NONAKA, Kawasaki-shi (JP); Ai Miyata, Hirakata-shi (JP); Keisuke Okamoto, Chofu-shi (JP); Yuka Takiguchi, Fukaya-shi (JP); Nahoko Shibano, Tokyo (JP); Yuta Shishime, Tokyo (JP); Tsuyoshi Okada, Nagoya-shi (JP); Shota Komatsu, Kobe-shi (JP)

(73) Assignees: TOYOTA JIDOSHA KABUSHIKI KAISHA, Toyota-shi (JP); DENSO TEN Limited, Kobe (JP)

(21) Appl. No.: 18/614,796

(22) Filed: Mar. 25, 2024

(30) Foreign Application Priority Data
Mar. 29, 2023 (JP) 2023-054211

(51) Int. Cl. G06Q 30/0601; G06Q 10/02; G08G 1/00

(52) U.S. Cl. CPC G06Q 30/0631; G06Q 10/02; G08G 1/202

(57) ABSTRACT

An information processing apparatus includes a controller configured to: divide a plurality of visitors into two or more groups based on reserved seat information; dispatch one or more vehicles for transporting the visitors to an event site group by group, the visitors belonging to any one of the divided groups; select the recommended goods that the visitors belonging to the any one of the groups use at the event site; and determine a content prompting the visitors belonging to the any one of the groups to purchase the recommended goods.

### CROSS-REFERENCE TO RELATED APPLICATION

This application claims priority to Japanese Patent Application No. 2023-054211 filed on Mar. 29, 2023, incorporated herein by reference in its entirety.

### BACKGROUND

### 1. Technical Field

The disclosure relates to an information processing apparatus, an information processing method, and a non-transitory storage medium.

### 2. Description of Related Art

When an event takes place, vehicles that transport visitors (spectators, audience, or the like) to an event site are operated. For example, Japanese Unexamined Patent Application Publication No. 2022-080651 (JP 2022-080651 A) describes a technology for transporting visitors to an event site by share ride. Also, at an event site, information about goods for sale (supporting goods and the like) that visitors use to work on an event, such as to support players or artists, is flooding.

### SUMMARY

In order for visitors to support players or artists and furthermore for the visitors themselves to be excited, diversification of the way in which visitors work on an event is desired. One example for that is to sell goods to visitors according to their seating positions. However, a technology for providing information on recommended goods according to seating positions of visitors has not been known.

Therefore, there is room for improvement in the technology for providing information on recommended goods.

The disclosure improves a technology for providing information on recommended goods.

A first aspect of the disclosure provides an information processing apparatus. The information processing apparatus is configured to provide information on recommended goods. The information processing apparatus includes a controller. The controller is configured to: divide a plurality of visitors into two or more groups based on reserved seat information; dispatch one or more vehicles for transporting the visitors to an event site group by group, the visitors belonging to any one of the divided groups; select the recommended goods that the visitors belonging to the any one of the groups use at the event site; and determine a content prompting the visitors belonging to the any one of the groups to purchase the recommended goods.

A second aspect of the disclosure provides an information processing method. The information processing method is executed by an information processing apparatus configured to provide information on recommended goods. The information processing method includes: dividing a plurality of visitors into two or more groups based on reserved seat information; dispatching one or more vehicles for transporting the visitors to an event site group by group, the visitors belonging to any one of the divided groups; selecting the recommended goods that the visitors belonging to the any one of the groups use at the event site; and determining a content prompting the visitors belonging to the any one of the groups to purchase the recommended goods.

A third aspect of the disclosure provides a non-transitory storage medium. The non-transitory storage medium stores instructions executable on one or more processors of an information processing apparatus configured to provide information on recommended goods. The instructions cause the one or more processors to execute functions. The functions include: dividing a plurality of visitors into two or more groups based on reserved seat information; dispatching one or more vehicles for transporting the visitors to an event site group by group, the visitors belonging to any one of the divided groups; selecting the recommended goods that the visitors belonging to the any one of the groups use at the event site; and determining a content prompting the visitors belonging to the any one of the groups to purchase the recommended goods.

According to the aspects of the disclosure, a technology for providing information on recommended goods is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram that shows the schematic configuration of a system according to an embodiment of the disclosure;

FIG. 2 is a flowchart that shows the operations of an information processing apparatus; and

FIG. 3 is a diagram that shows the outline of an event site.

### DETAILED DESCRIPTION OF EMBODIMENTS

Hereinafter, an embodiment of the disclosure will be described.

### Outline of Embodiment

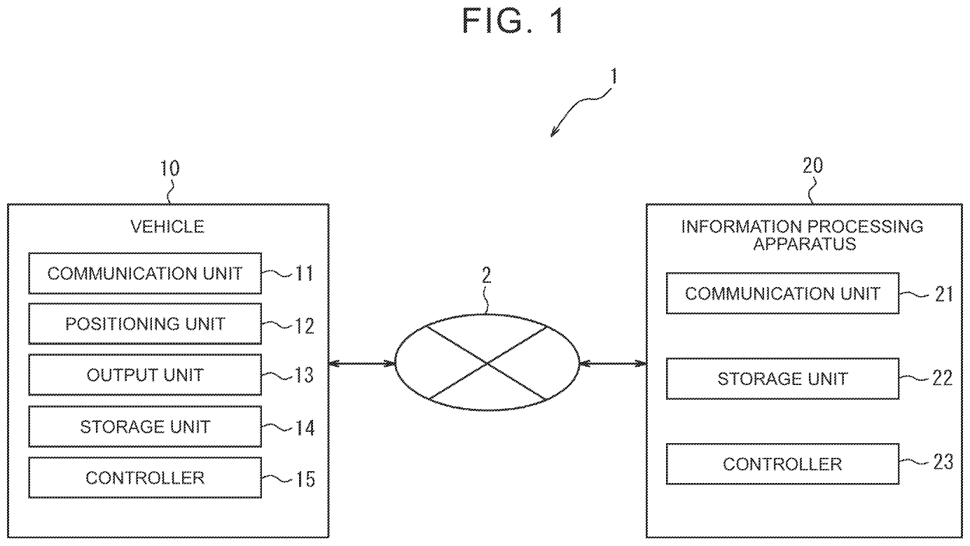

The outline of a system 1 according to the embodiment of the disclosure will be described with reference to FIG. 1. The system 1 includes a vehicle 10 and an information processing apparatus 20. The vehicle 10 and the information processing apparatus 20 are connected to a network 2 such that communication is possible. Examples of the network 2 include the Internet and a mobile communication network.

The vehicle 10 is, for example, an automobile; however, the vehicle 10 is not limited thereto and may be any vehicle. Examples of the automobile include a gasoline vehicle, a battery electric vehicle (BEV), a hybrid electric vehicle (HEV), a plug-in hybrid electric vehicle (PHEV), and a fuel cell electric vehicle (FCEV); however, the automobile is not limited thereto. The number of vehicles 10 included in the system 1 may be selectively determined.

In the present embodiment, the vehicle 10 transports a plurality of visitors to an event site. One or more vehicles 10 that accommodate all the plurality of visitors may be configured to be operated with shifted departure time, shifted arrival time, or shifted departure time and arrival time. The vehicle 10 may be configured to be operated in a section from a predetermined departure place, such as a station square, to the event site. The vehicle 10 may present a content prompting the plurality of visitors to purchase recommended goods in a vehicle cabin while transporting the plurality of visitors to the event site. The vehicle 10 is connected to the information processing apparatus 20 via the network 2 such that communication is possible.

The information processing apparatus 20 is, for example, a computer, such as a server apparatus. The information processing apparatus 20 is connected to the vehicle 10 via the network 2 such that communication is possible.

The outline of the present embodiment will be described first, and the details will be described later. The information processing apparatus 20 divides a plurality of visitors into two or more groups based on reserved seat information, dispatches one or more vehicles for transporting the visitors to an event site group by group, the visitors belonging to any one of the divided groups, selects the recommended goods that the visitors belonging to the any one of the groups use at the event site, and determines a content prompting the visitors belonging to the any one of the groups to purchase the recommended goods.

In this way, according to the present embodiment, recommended goods are presented for each of the groups into which the plurality of visitors is divided. As a result, the plurality of visitors is able to learn information on recommended goods according to their seating positions. Therefore, a technology for providing information on recommended goods is improved in terms of improvement in the probability that visitors purchase recommended goods according to their seating positions.

Next, the components of the system 1 will be described in detail.

### Configuration of Vehicle

As shown in FIG. 1, the vehicle 10 includes a communication unit 11, a positioning unit 12, an output unit 13, a storage unit 14, and a controller 15.

The communication unit 11 includes one or more communication interfaces for connection with the network 2. The communication interface supports, for example, a mobile communication standard, such as 4th Generation (4G) and 5th Generation (5G); however, the communication interface is not limited thereto. In the present embodiment, the vehicle 10 communicates with the information processing apparatus 20 via the communication unit 11 and the network 2.

The positioning unit 12 includes one or more devices that acquire information about the position of the vehicle 10. Specifically, the positioning unit 12 includes, for example, a receiver that supports GPS; however, the configuration is not limited thereto. The positioning unit 12 may include a receiver that supports a selected satellite positioning system.

The output unit 13 is configured to include at least one voice output interface capable of outputting voice and at least one display interface capable of displaying text or video. The voice output interface is, for example, a speaker. The display interface is, for example, a display, such as an LCD and an organic EL display. The voice output interface and the display interface are not limited thereto.

The storage unit 14 includes one or more memories. Examples of the memory include a semiconductor memory, a magnetic memory, and an optical memory; however, the memory is not limited thereto. Each memory included in the storage unit 14 may function as, for example, a main storage device, an auxiliary storage device, or a cache memory. The storage unit 14 stores selected information used in the operation of the vehicle 10. For example, the storage unit 14 may store a system program, an application program, embedded software, a service schedule of the host vehicle, received from the information processing apparatus 20, identification information of each of a plurality of visitors who get a ride on the host vehicle, and the like. Information stored in the storage unit 14 may be allowed to be updated with, for example, information acquired from the network 2 via the communication unit 11.

The controller 15 includes one or more processors, one or more programmable circuits, one or more dedicated circuits, or a combination of them. The processor is, for example, a general-purpose processor, such as a central processing unit (CPU) and a graphics processing unit (GPU), or a special-purpose processor specialized in a specific process; however, the processor is not limited thereto. The programmable circuit is, for example, a field-programmable gate array (FPGA); however, the programmable circuit is not limited thereto. The dedicated circuit is, for example, an application specific integrated circuit (ASIC); however, the dedicated circuit is not limited thereto. The controller 15 controls the overall operation of the vehicle 10.

### Configuration of Information Processing Apparatus

As shown in FIG. 1, the information processing apparatus 20 includes a communication unit 21, a storage unit 22, and a controller 23.

The communication unit 21 includes one or more communication interfaces for connection with the network 2. The communication interface supports, for example, a mobile communication standard, a wired local area network (LAN) standard, or a wireless LAN standard; however, the standard supported by the communication interface is not limited thereto. The communication interface may support a selected communication standard. In the present embodiment, the information processing apparatus 20 communicates with the vehicle 10 via the communication unit 21 and the network 2.

The storage unit 22 includes one or more memories. Each memory included in the storage unit 22 may function as, for example, a main storage device, an auxiliary storage device, or a cache memory. The storage unit 22 stores selected information used in the operation of the information processing apparatus 20. For example, the storage unit 22 may store a system program, an application program, a database, and information recording identification information of each of the plurality of visitors, a visit history, and a goods purchase history at each visit in association with one another. Information stored in the storage unit 22 may be allowed to be updated with, for example, information acquired from the network 2 via the communication unit 21.

The controller 23 includes one or more processors, one or more programmable circuits, one or more dedicated circuits, or a combination of them. The controller 23 controls the overall operation of the information processing apparatus 20.

### Operation Flow of Information Processing Apparatus

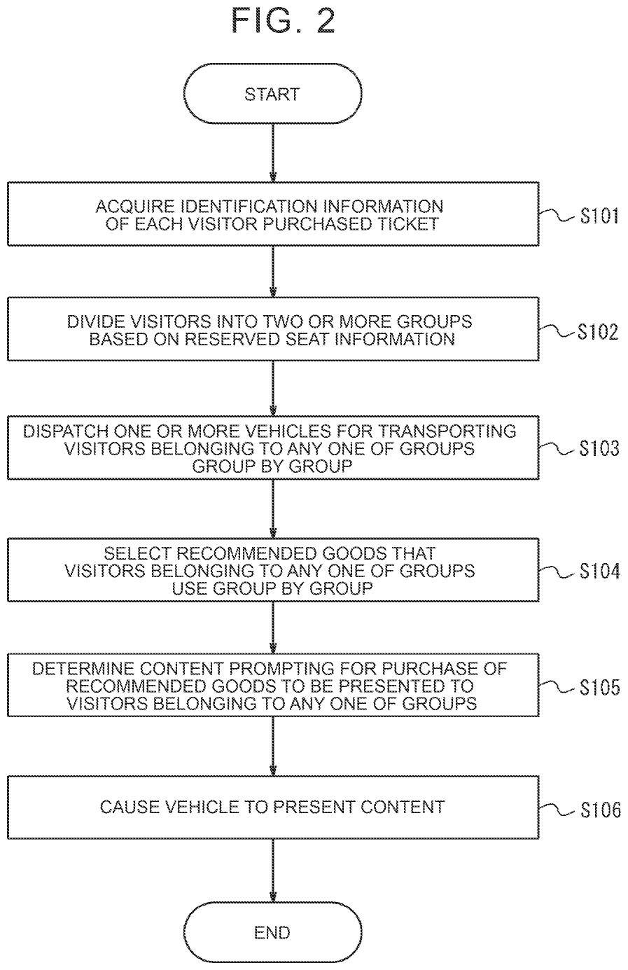

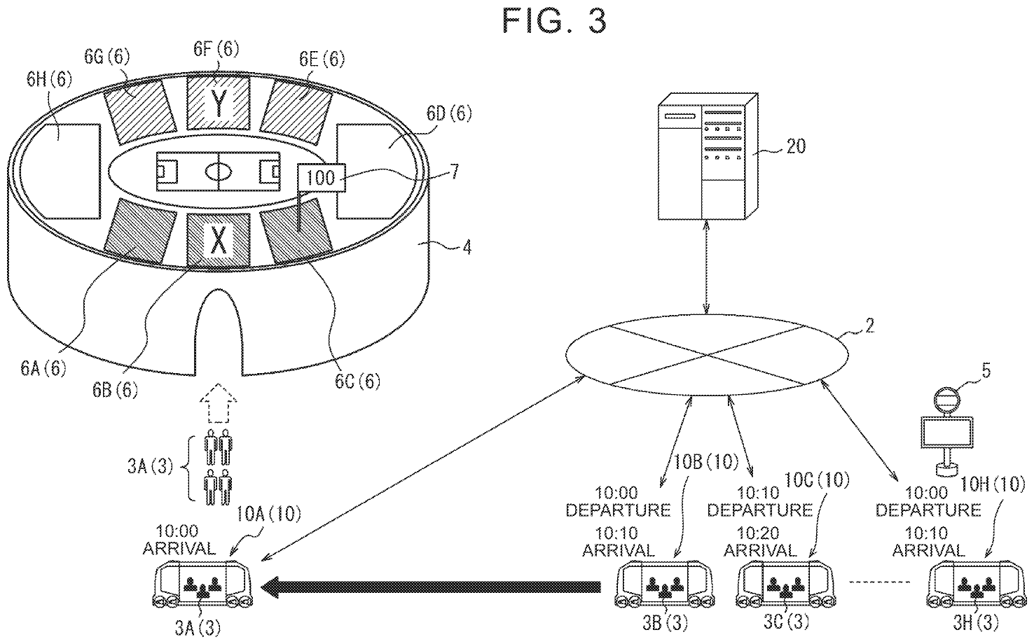

FIG. 2 is a flowchart that shows the operation of the information processing apparatus 20. FIG. 3 is a diagram that shows the outline of an event site 4. The operation of the information processing apparatus 20 according to the present embodiment will be described with reference to FIG. 2 and FIG. 3. The operation relates to provision of information on recommended goods 7 to be sold at the event site 4.

In step S101, the controller 23 acquires identification information of a plurality of visitors 3 (3A, 3B, 3C, 3D, 3E, 3F, 3G, 3H) who respectively purchased tickets for an event.

The controller 23 acquires identification information of the visitors 3 who respectively purchased tickets for the event from a server of a dealer that sells a ticket for the event via the communication unit 21 and the network 2. Each of the visitors 3A, 3B, 3C, 3D, 3E, 3F, 3G, 3H is composed of a plurality of visitors.

The storage unit 22 may record identification information, a visit history, and a goods purchase history at each visit, of each of the plurality of visitors 3, in association with one another. The storage unit 22 may record a visit history and a goods purchase history this time by adding the visit history and the goods purchase history to a past visit history and a past goods purchase history stored in the storage unit 22 for each individual visitor 3 in association with one another based on the identification information of the visitors 3, acquired from the server of the dealer.

In step S102, the controller 23 divides the visitors 3 into two or more groups based on reserved seat information.

In the present embodiment, the reserved seat information is seating positions 6 (6A, 6B, 6C, 6D, 6E, 6F, 6G, 6H). The controller 23 may cause the visitors 3, of which the seating positions 6 are in a predetermined range, to belong to the same group. As shown in FIG. 3, the seating positions 6A, 6B, 6C, 6D, 6E, 6F, 6G, 6H are seating positions in the predetermined range. The controller 23 may cause the visitors 3A, 3B, 3C, 3D, 3E, 3F, 3G, 3H to belong to the same groups, respectively. The visitors 3A, 3B, 3C, 3D, 3E, 3F, 3G, 3H are respectively seated at the seating positions 6A, 6B, 6C, 6D, 6E, 6F, 6G, 6H. The seating positions 6 (6A, 6B, 6C, 6D, 6E, 6F, 6G, 6H) are determined by the visitors 3 at the time when the visitors 3 purchase tickets based on a supporting team, presence, a view, a ticket price, and the like.

The controller 23 may cause the visitors 3 at the seating positions 6, arranged to express a specific shape or design, to belong to the same group. As shown in FIG. 3, the seating positions 6B are arranged to display a human letter of “X”, and the seating positions 6F are arranged to display a human letter of “Y”. The controller 23 may cause the visitors 3B seated at the seating positions 6B to belong to the same group and may cause the visitors 3F seated at the seating positions 6F to belong to the same group.

In step S103, the controller 23 dispatches one or more vehicles 10 for transporting the visitors 3 belonging to any one of the divided groups to the event site 4 group by group.

The controller 23 dispatches one or more vehicles 10 (10A, 10B, 10C, 10D, 10E, 10F, 10G, 10H) for transporting the visitors 3 (3A, 3B, 3C, 3D, 3E, 3F, 3G, 3H) belonging to any one of the groups from a predetermined departure place 5 to the event site 4 group by group. When the number of the visitors 3 belonging to any one of the groups (for example, the visitors 3A belonging to the group A) exceeds the riding capacity of the vehicle 10, the controller 23 may dispatch two or more vehicles 10 for giving a ride to the visitors 3A separately. The controller 23 plans a service schedule of one or more vehicles 10 for giving a ride to the visitors 3 belonging to any one of the groups group by group. To reduce congestion at the event site 4, the controller 23 may plan a service schedule of one or more vehicles 10 such that departure time from the predetermined departure place 5, arrival time at the event site 4, or departure time and arrival time are shifted by a predetermined period of time T. The predetermined period of time T is set to 10 minutes for the sake of convenience of description; however, the predetermined period of time T is not limited to 10 minutes and may be selectively determined.

In step S104, the controller 23 selects the recommended goods 7 that the visitors 3 belonging to the any one of the groups use at the event site 4 group by group.

The recommended goods 7 are goods (supporting goods) that the information processing apparatus 20 recommends for the visitors according to their seating positions 6. The recommended goods 7 are banners, T-shirts, uniforms, megaphones, fans, stick balloons, towels, flags, panels (including panels for human letters), caps, or the like; however, the recommended goods 7 are not limited thereto. FIG. 3 illustrates a flag showing uniform number 100 with a large scale, of a player of team X as the recommended goods 7.

The controller 23 may select goods in the same category as goods of which the number of goods sold and purchased before is greater than or equal to a first threshold, for the recommended goods 7 based on the goods purchase histories of the visitors 3 belonging to the any one of the divided groups. The category of goods may be a banner, a T-shirts, a uniform, a megaphone, a fan, a stick balloon, a towel, a flag, a panel, a cap, or the like. When most of the visitors 3 of which the seating positions 6 are in a predetermined range use the same recommended goods 7, the visitors 3 at the seating positions 6 in the predetermined range are able to cheer as one. In one example of FIG. 3, when, for example, it is assumed that the seating positions 6A, 6B, 6C in the predetermined range are seating positions for supporters of team X, the visitors 3A, 3B, 3C are able to cheer up team X and can feel a sense of togetherness if the visitors 3A, 3B, 3C at the seating positions 6A, 6B, 6C use the recommended goods 7 colored with a team color of team X.

The controller 23 may select goods in the same category as goods of which the number of goods sold and purchased before is less than a second threshold, for the recommended goods 7 based on the goods purchase histories of the visitors 3 belonging to the any one of the divided groups. Even when goods are used by a small number of visitors 3, but when recommended goods 7 that highly appeal to a specific player or performer are selected, it is possible to cheer up the specific player or performer. For example, as shown in FIG. 3, if the visitors 3C use the recommended goods 7 showing the uniform number 100 of a player whose popularity and name recognition are not necessarily high in the supporting team X, for supporting at the seating positions 6C, it is possible to cheer up the player usually inconspicuous.

When the visitors 3B at the seating positions 6B or the visitors 3F at the seating positions 6F, arranged to express a specific shape or design, are caused to belong to the same group, the controller 23 may select goods associated in advance with expression of the specific shape or design for the recommended goods 7. When the visitors 3B at the seating positions 6B use the recommended goods 7, such as two or more-color panels and caps, for expressing a specific shape or design based on a predetermined rule, the visitors 3B are able to cheer with a mass game (for example, the human letter “X” in FIG. 3) at the seats. When the visitors 3F at the seating positions 6F use the recommended goods 7, such as two or more-color panels and caps, for expressing a specific shape or design based on a predetermined rule, the visitors 3F are able to cheer with a mass game (for example, the human letter “Y” in FIG. 3) at the seats.

In step S105, the controller 23 determines a content prompting the visitors 3 belonging to the any one of the groups to purchase the recommended goods 7.

The controller 23 determines a content using a video or a voice to introduce the recommended goods 7 to be sold for the any one of the groups group by group and distributes the content to each of the vehicles 10 on which the visitors 3 of the any one of the groups are riding.

The content prompting for purchase of the recommended goods 7 may include information indicating the effect in a case where the recommended goods 7 are purchased. The content is presented by the output unit 13 including a speaker and a display in the vehicle cabin of the in-service vehicle 10. The content may include a demonstration video using the recommended goods 7 at the actual event site 4. If the visitors 3 are able to imagine a scene in which the recommended goods 7 are actually used, the purchase motivations of the visitors 3 are stimulated, and the sale of the recommended goods 7 is facilitated.

The content prompting for purchase of the recommended goods 7 may include information indicating a difference between the recommended goods 7 and goods in the same category sold before. When the recommended goods 7 are goods in the same category as goods sold before, it is possible to briefly tell a difference between new and old goods to the visitors 3 purchased the goods sold before, so the sale of the recommended goods 7 is facilitated.

In step S106, the controller 23 causes the vehicle 10 to present the content.

The vehicle 10 receives the content determined by the controller 23 of the information processing apparatus 20 via the communication unit 11 and the network 2. Then, the content is presented by the output unit 13 including a speaker and a display to the visitors 3 belonging to the any one of the groups in the vehicle cabin of the in-service vehicle 10.

As described above, the information processing apparatus 20 according to the present embodiment divides a plurality of visitors 3 into two or more groups based on reserved seat information, dispatches one or more vehicles 10 for transporting the visitors 3 to an event site 4 group by group, the visitors 3 belonging to any one of the divided groups, selects the recommended goods 7 that the visitors 3 belonging to the any one of the groups use at the event site 4, and determines a content prompting the visitors 3 belonging to the any one of the groups to purchase the recommended goods 7.

With the above configuration, the recommended goods 7 are presented for each of the groups into which the visitors 3 are divided. As a result, the visitors 3 are able to learn information on recommended goods 7 according to their seating positions 6. Therefore, a technology for providing information on the recommended goods 7 is improved in terms of improvement in the probability that the visitors 3 purchase the recommended goods 7 according to their seating positions 6.

The disclosure has been described based on the drawings and the embodiment, and it is noted that persons skilled in the art can make various modifications and alterations based on the disclosure. Therefore, it should be noted that the scope of the disclosure encompasses these modifications and alterations. For example, the functions and the like included in the components, steps, or the like, may be rearranged without any logical contradiction, and a plurality of components, steps, or the like may be combined as one or each component, step, or the like may be divided.

For example, in the above-described embodiment, an embodiment in which the configuration and operation of the information processing apparatus 20 are distributed to a plurality of computers such that communication is possible with one another is applicable. For example, an embodiment in which one or some component elements of the information processing apparatus 20 are provided in another server connected such that communication is possible is applicable. For example, an operation to record identification information of each of the visitors 3, a visit history, and a goods purchase history at each visit in association with one another may be executed in the another server. In this case, the information processing apparatus 20 is allowed to acquire the identification information and the like of each of the visitors 3 from the another server, so the memory capacity of the storage unit 22 is saved.

For example, a general-purpose computer may be configured to function as the information processing apparatus 20 according to the above-described embodiment. Specifically, a program describing the process details to implement the functions of the information processing apparatus 20 according to the above-described embodiment is stored in a memory of a general-purpose computer, and the program is read and run by a processor. The disclosure may be implemented by a program executable on a processor or a non-transitory computer-readable medium storing the program.

Hereinafter, some of embodiments of the disclosure will be described. However, embodiments of the disclosure are not limited to these embodiments.

### Addendum 1

An information processing apparatus according to a first aspect of the disclosure is configured to provide information on recommended goods. The information processing apparatus includes a controller. The controller is configured to: divide a plurality of visitors into two or more groups based on reserved seat information; dispatch one or more vehicles for transporting the visitors to an event site group by group, the visitors belonging to any one of the divided groups; select the recommended goods that the visitors belonging to the any one of the groups use at the event site; and determine a content prompting the visitors belonging to the any one of the groups to purchase the recommended goods.

### Addendum 2

In the information processing apparatus according to the first aspect of the disclosure, the reserved seat information may be seating positions. The controller may be configured to cause the visitors, of which the seating positions are in a predetermined range, to belong to the same group.

### Addendum 3

In the information processing apparatus according to the first aspect of the disclosure, the controller may be configured to cause the visitors at seating positions arranged to express a specific shape or design, to belong to the same group, and the controller may be configured to select, for the recommended goods, goods associated in advance with an expression for the specific shape or design.

### Addendum 4

The information processing apparatus according to the first aspect of the disclosure may further include a recording unit configured to record identification information of each of the plurality of visitors, a visit history, and a goods purchase history at each visit in association with one another.

### Addendum 5

In the information processing apparatus according to the first aspect of the disclosure, the controller may be configured to select goods in the same category as goods of which the number of goods sold and purchased before is greater than or equal to a first threshold, based on the goods purchase history of each of the visitors belonging to the any one of the groups, for the recommended goods.

### Addendum 6

In the information processing apparatus according to the first aspect of the disclosure, the controller may be configured to select goods in the same category as goods of which the number of goods sold and purchased before is less than a second threshold, based on the goods purchase history of each of the visitors belonging to the any one of the groups, for the recommended goods.

### Addendum 7

In the information processing apparatus according to the first aspect of the disclosure, the content prompting for purchase of the recommended goods may include information indicating an effect in a case where the recommended goods are purchased.

### Addendum 8

In the information processing apparatus according to the first aspect of the disclosure, the content prompting for purchase of the recommended goods may include information indicating a difference between the recommended goods and goods in the same category sold before.

### Addendum 9

An information processing method according to a second aspect of the disclosure is executed by an information processing apparatus configured to provide information on recommended goods. The information processing method includes: dividing a plurality of visitors into two or more groups based on reserved seat information; dispatching one or more vehicles for transporting the visitors to an event site group by group, the visitors belonging to any one of the divided groups; selecting the recommended goods that the visitors belonging to the any one of the groups use at the event site; and determining a content prompting the visitors belonging to the any one of the groups to purchase the recommended goods.

### Addendum 10

In the information processing method according to the second aspect of the disclosure, the reserved seat information may be seating positions, and the information processing method may further include causing the visitors, of which the seating positions are in a predetermined range, to belong to the same group.

### Addendum 11

The information processing method according to the second aspect of the disclosure may further include causing the visitors at seating positions arranged to express a specific shape or design, to belong to the same group; and selecting, for the recommended goods, goods associated in advance with an expression for the specific shape or design.

### Addendum 12

The information processing method according to the second aspect of the disclosure may further include recording identification information of each of the plurality of visitors, a visit history, and a goods purchase history at each visit in association with one another.

### Addendum 13

The information processing method according to the second aspect of the disclosure may further include selecting goods in the same category as goods of which the number of goods sold and purchased before is greater than or equal to a first threshold, based on the goods purchase history of each of the visitors belonging to the any one of the groups, for the recommended goods.

### Addendum 14

The information processing method according to the second aspect of the disclosure may further include selecting goods in the same category as goods of which the number of goods sold and purchased before is less than a second threshold, based on the goods purchase history of each of the visitors belonging to the any one of the groups, for the recommended goods.

### Addendum 15

In the information processing method according to the second aspect of the disclosure, the content prompting for purchase of the recommended goods may include information indicating an effect in a case where the recommended goods are purchased.

### Addendum 16

In the information processing method according to the second aspect of the disclosure, the content prompting for purchase of the recommended goods may include information indicating a difference between the recommended goods and goods in the same category sold before.

### Addendum 17

A non-transitory storage medium according to a third aspect of the disclosure stores instructions executable on one or more processors of an information processing apparatus configured to provide information on recommended goods. The instructions cause the one or more processors to execute functions. The functions include: dividing a plurality of visitors into two or more groups based on reserved seat information; dispatching one or more vehicles for transporting the visitors to an event site group by group, the visitors belonging to any one of the divided groups; selecting the recommended goods that the visitors belonging to the any one of the groups use at the event site; and determining a content prompting the visitors belonging to the any one of the groups to purchase the recommended goods.

### Addendum 18

In the non-transitory storage medium according to the third aspect of the disclosure, the reserved seat information may be seating positions. The functions may further include causing the visitors, of which the seating positions are in a predetermined range, to belong to the same group.

### Addendum 19

In the non-transitory storage medium according to the third aspect of the disclosure, the functions may further include causing the visitors at seating positions arranged to express a specific shape or design, to belong to the same group; and selecting, for the recommended goods, goods associated in advance with an expression for the specific shape or design.

### Addendum 20

In the non-transitory storage medium according to the third aspect of the disclosure, the functions may further include recording identification information of each of the plurality of visitors, a visit history, and a goods purchase history at each visit in association with one another.

What is claimed is:

1. An information processing apparatus configured to provide information on recommended goods, the information processing apparatus comprising a controller configured to:
divide a plurality of visitors into two or more groups based on reserved seat information;
dispatch one or more vehicles for transporting the visitors to an event site group by group, the visitors belonging to any one of the divided groups;
select the recommended goods that the visitors belonging to the any one of the groups use at the event site; and
determine a content prompting the visitors belonging to the any one of the groups to purchase the recommended goods.

2. The information processing apparatus according to claim 1, wherein:
the reserved seat information is seating positions; and
the controller is configured to cause the visitors, of which the seating positions are in a predetermined range, to belong to the same group.

3. The information processing apparatus according to claim 2, wherein:
the controller is configured to cause the visitors at seating positions arranged to express a specific shape or design, to belong to the same group; and
the controller is configured to select, for the recommended goods, goods associated in advance with an expression for the specific shape or design.

4. The information processing apparatus according to claim 1, further comprising a recording unit configured to record identification information of each of the plurality of visitors, a visit history, and a goods purchase history at each visit in association with one another.

5. The information processing apparatus according to claim 4, wherein the controller is configured to select goods in the same category as goods of which the number of goods sold and purchased before is greater than or equal to a first threshold, based on the goods purchase history of each of the visitors belonging to the any one of the groups, for the recommended goods.

6. The information processing apparatus according to claim 4, wherein the controller is configured to select goods in the same category as goods of which the number of goods sold and purchased before is less than a second threshold, based on the goods purchase history of each of the visitors belonging to the any one of the groups, for the recommended goods.

7. The information processing apparatus according to claim 1, wherein the content prompting for purchase of the recommended goods includes information indicating an effect in a case where the recommended goods are purchased.

8. The information processing apparatus according to claim 1, wherein the content prompting for purchase of the recommended goods includes information indicating a difference between the recommended goods and goods in the same category sold before.

9. An information processing method executed by an information processing apparatus configured to provide information on recommended goods, the information processing method comprising:
dividing a plurality of visitors into two or more groups based on reserved seat information;
dispatching one or more vehicles for transporting the visitors to an event site group by group, the visitors belonging to any one of the divided groups;
selecting the recommended goods that the visitors belonging to the any one of the groups use at the event site; and
determining a content prompting the visitors belonging to the any one of the groups to purchase the recommended goods.

10. The information processing method according to claim 9, wherein:
the reserved seat information is seating positions; and
the information processing method further comprises causing the visitors, of which the seating positions are in a predetermined range, to belong to the same group.

11. The information processing method according to claim 10, further comprising:
causing the visitors at seating positions arranged to express a specific shape or design, to belong to the same group; and
selecting, for the recommended goods, goods associated in advance with an expression for the specific shape or design.

12. The information processing method according to claim 9, further comprising recording identification information of each of the plurality of visitors, a visit history, and a goods purchase history at each visit in association with one another.

13. The information processing method according to claim 12, further comprising selecting goods in the same category as goods of which the number of goods sold and purchased before is greater than or equal to a first threshold, based on the goods purchase history of each of the visitors belonging to the any one of the groups, for the recommended goods.

14. The information processing method according to claim 12, further comprising selecting goods in the same category as goods of which the number of goods sold and purchased before is less than a second threshold, based on the goods purchase history of each of the visitors belonging to the any one of the groups, for the recommended goods.

15. The information processing method according to claim 9, wherein the content prompting for purchase of the recommended goods includes information indicating an effect in a case where the recommended goods are purchased.

16. The information processing method according to claim 9, wherein the content prompting for purchase of the recommended goods includes information indicating a difference between the recommended goods and goods in the same category sold before.

17. A non-transitory storage medium storing instructions executable on one or more processors of an information processing apparatus configured to provide information on recommended goods, the instructions causing the one or more processors to execute functions, the functions comprising:
dividing a plurality of visitors into two or more groups based on reserved seat information;
dispatching one or more vehicles for transporting the visitors to an event site group by group, the visitors belonging to any one of the divided groups;
selecting the recommended goods that the visitors belonging to the any one of the groups use at the event site; and
determining a content prompting the visitors belonging to the any one of the groups to purchase the recommended goods.

18. The non-transitory storage medium according to claim 17, wherein:
the reserved seat information is seating positions; and
the functions further comprise causing the visitors, of which the seating positions are in a predetermined range, to belong to the same group.

19. The non-transitory storage medium according to claim 18, wherein the functions further comprise:
causing the visitors at seating positions arranged to express a specific shape or design, to belong to the same group; and
selecting, for the recommended goods, goods associated in advance with an expression for the specific shape or design.

20. The non-transitory storage medium according to claim 17, wherein the functions further comprise recording identification information of each of the plurality of visitors, a visit history, and a goods purchase history at each visit in association with one another.
